(19) United States
(12) Patent Application Publication
(10) Pub. No.: US 2007/0099152 A1
(43) Pub. Date: May 3, 2007

(54) Dental implant system

(76) Inventors: Albert Busch, Chicago, IL (US); Elaine A. Stuebner, Miami Beach, FL (US); Steven A. Greenberg, Highland Park, IL (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/263,211

(22) Filed: Oct. 31, 2005

(51) Int. Cl. A61C 8/00

(52) U.S. Cl. 433/173; 433/174

(57) ABSTRACT

A dental implant (22) for surgical placement in a living jaw bone at least partially covered with gingival tissue and for mounting a cosmetic tooth prosthesis. The implant (22) includes an elongated body portion (24) to be received by the living jaw bone and an abutment portion (26) extending from the jaw bone and at least partially past the gingival tissue for receiving the cosmetic tooth prosthesis, wherein the body portion and the abutment portion form a single unit. The implant (22) further has a narrow profile.

### CROSS-REFERENCE TO RELATED APPLICATIONS

None.

### TECHNICAL FIELD

This invention relates generally to a dental implant system and method of using same and more specifically to a one-piece dental implant.

### BACKGROUND OF THE INVENTION

Implant dentistry involves the restoration of one or more teeth in a patient's mouth using artificial components. Such artificial components typically include a dental implant, an abutment connected to the implant, and a prosthesis or artificial tooth secured to the abutment. The process for restoring a tooth is typically carried out in three stages.

Stage I involves implanting the dental implant into the living bone of a patient's jaw. The oral surgeon first accesses the patient's jaw bone through the patient's gingival or gum tissue and removes any remains of the tooth to be replaced. Next, the specific site in the patient's jaw where the implant is to be anchored is made or widened by drilling and/or reaming to accommodate the width of the dental implant to be implanted. Then, the dental implant is inserted into the hole in the jaw bone.

The implant itself is typically fabricated from pure titanium or a titanium alloy. Such materials are known to produce osseointegration of the implant fixture with the patient's jaw bone. Osseointegration is a process by which the living bone surrounding the implant will proliferate and grow into whatever spaces exist between the implant and the bone surfaces.

In this way the newly generated bone tissue encases the implant to securely hold or anchor it in place. The dental implant fixture has also typically included a hollow threaded bore through at least a portion of its body and extending out through its proximal end which is exposed through the crestal jaw bone. The hollow threaded bore typically receives a dental abutment, either directly or by virtue of a separate securing device such as an abutment screw. The abutment ultimately supports the final tooth prosthesis. The prosthesis is typically secured to the abutment either by a cement or other adhesive or by use of a fastener such as a screw.

After the implant is initially installed in the jaw bone, a healing screw (a cover) is secured over the exposed proximal end in order to seal the internal bore of the implant body. The patient's gums are then sutured over the screw covered implant to allow the implant site to heal and to allow desired osseointegration to occur. Complete osseointegration typically takes several months, ending this Stage 1 phase.

During Stage II, the surgeon reaccesses the implant fixture by making an incision through the patient's gum tissues. The healing cover screw is then removed, exposing the proximal end of the implant. The hollow threaded bore of the implant is thoroughly cleaned and dried. The surgeon then attaches a temporary cap secured by a cover screw, which is screwed directly through the healing cap into the hollow threaded bore of the implant. The gingival tissues are again closed around the cap and sutured in place. To accurately record the position, the orientation and the shape of the final abutment, the surgeon can take a mold or impression of the patient's mouth. The impression, which includes the implant abutment sites, is then sent to the laboratory and is used to create a plaster or stone model which is a direct duplication of the patient's mouth. This provides the information needed to fabricate the prosthetic replacement tooth or any required intermediate prosthetic components. Stage II is now typically completed.

Based on this Stage II model, the technician will construct the final restoration. The final five (5) steps required to complete the restorative procedures are as follows:
1) The sutures are removed;
2) The healing cap and the healing cap screw are removed;
3) The exposed hollow threaded bore of the implant body is thoroughly cleaned and dried;
4) The solid abutment is screwed into the implant body's hollow threaded bore; and,
5) The cosmetic final prosthesis is secured to the patient's mouth abutments with a dental adhesive cement.

Dental implant systems of the prior art include multiple parts which are attached to each other in final usage, making the technique complex and dentist unfriendly as described above. Also, having multiple pieces increases overall size and decreases overall strength and integrity of the final assembled unit.

The present invention provides an improved dental implant system and method. This system and method are simple, technique friendly with no component parts. In this invention there is no need for any component parts, such as a healing cap, a healing cap screw, a healing screw separant abutment component or a second surgical procedure involving the gingival tissue overgrowth to expose the top of the implant body to get access to the implant body threaded bore to place the solid abutment component.

### SUMMARY OF THE INVENTION

The present invention is directed to a one-piece unit which includes both the abutment section and the implant body, and no component parts. The dental implant when surgically placed in a living jaw bone is not covered with any gingival tissue. Subsequently, mounting a cosmetic tooth prosthesis to the exposed abutment is a simple procedure, exactly the same procedure as in the cementation of routine crowns. This is possible wherein the body portion and the abutment portion form a single unit. As a result of the present invention, the steps outlined above in Prior Type Stage II are unnecessary. Most significantly, the present invention allows implanting in narrow areas, such as those associated with lower front teeth and congenitally missing maxillary lateral incisors. Subsequently, the final placement of the cosmetic tooth prosthesis to the abutment portion is a familiar procedure. One merely cements the prosthesis to the exposed abutment section with an adhesive dental cement as one would do when cementing the routine crown to a tooth. There is thus no necessity to surgically remove any gingival tissue because initially, in the placement of the present new invention implant into the bone site, it does not require any surgical gingival flap procedures, as it does with the prior art implant placement procedures, during which time the gingival tissues must be sutured over the embedded implant body.

### BRIEF DESCRIPTION OF THE DRAWINGS

The dental implant system, and method of using same, of the invention will now be described with reference to the accompanying drawings in which:

FIG. 1 is an exploded view of a typical prior art dental implant assembly;

FIG. 2 is a perspective view of a dental implant according to the teachings of the present invention;

FIG. 3 is a side view of the dental implant of the present invention shown in FIG. 2;

FIG. 3a is a partial side view showing details of a threaded portion of the dental implant shown in FIG. 2;

FIG. 4 is a top view of the implant of FIG. 2;

FIG. 5 is a side view of an impression transfer thimble;

FIG. 5a is a top view of the thimble of FIG. 5;

FIG. 6 is a side sectional view of the thimble of FIG. 5;

FIG. 7 is a lower perspective view of the thimble of FIG. 5;

FIGS. 8a-8g schematically depict the process of creating a mold of a patient's mouth incorporating the implant of FIG. 2 and the thimble of FIG. 5;

FIG. 9 is a side sectional view of a pattern thimble;

FIG. 9A is a side sectional view of an alternative pattern thimble; and, FIG. 10 is a lower perspective view of the thimble of FIG. 9.

### DETAILED DESCRIPTION

While this invention is susceptible of embodiment in many different forms, there is shown in the drawings and will herein be described in detail preferred embodiment(s) of the invention with the understanding that the present disclosure is to be considered as an exemplification of the principles of the invention and is not intended to limit the broad aspect of the invention to the embodiments illustrated.

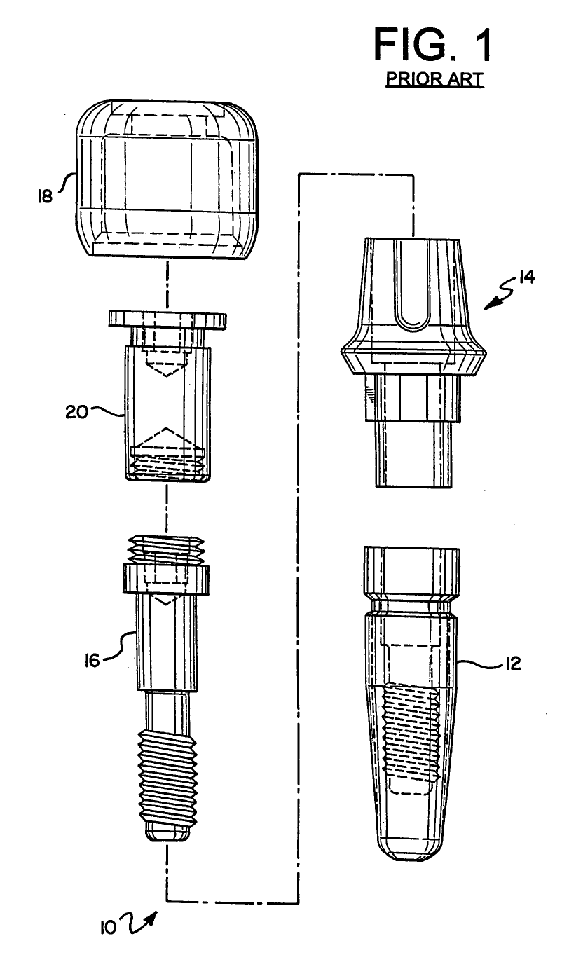

FIG. 1 depicts a dental implant assembly 10 of the prior art. The assembly 10 includes an implant 12, an abutment 14, and an abutment screw 16 for securing the abutment 14 to the implant 12. A healing cap 18, and a cap screw 20 for securing the cap 18 to the implant 12 and/or the abutment 14 may also be employed. Other dental implant assemblies are known in the prior art, all incorporating multiple components.

In use, the prior art implant 12 is inserted into a living jaw bone of a patient, after the insertion site is properly prepared by the oral surgeon in a manner similar to the above Stage I description. Then the abutment 14 is attached to the implant 12 by virtue of the abutment screw 16. An impression of the site and surrounding portions of the mouth may be taken at this point for use in creating a cast of the patient's mouth, either by a dentist or by a lab technician. The component parts 14 and 16 are removed and the healing cap 18 is then secured to the abutment 12 by use of the healing cap screw 20. The healing cap 18 is typically left in place while the gums heal and while the jaw bone further osseointegrates with the implant. At a later point, the healing cap 18 is removed and replaced by a final restorative tooth prosthesis secured to the abutment 14, by virtue of the abutment screw 16.

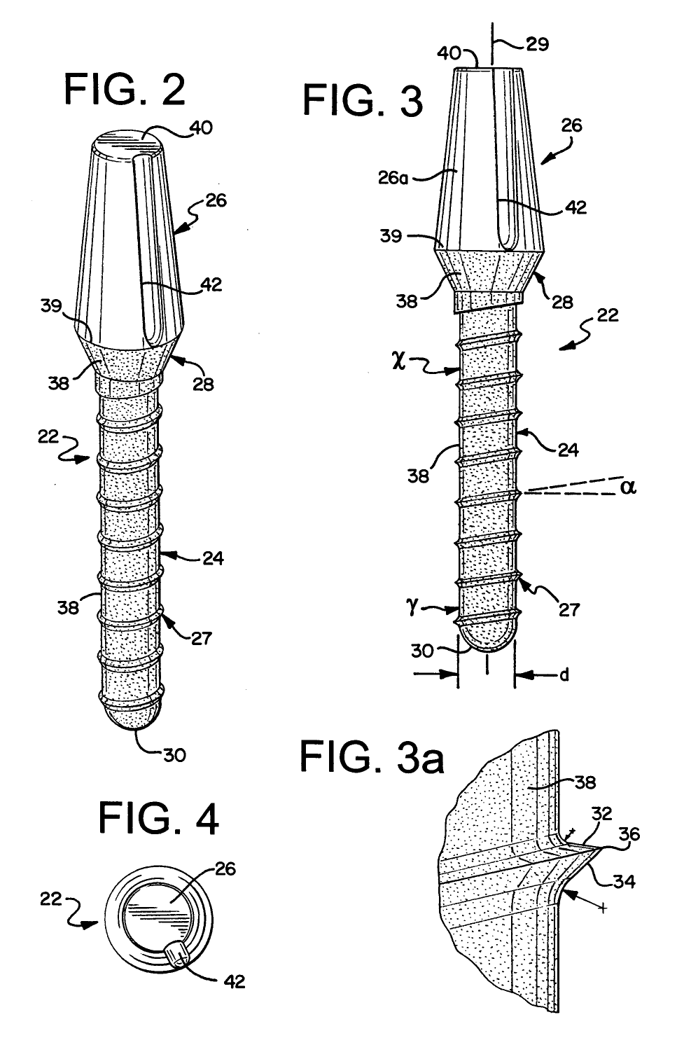

FIGS. 2-4 depict a dental implant 22 according to the present invention. The dental implant 22 is a single piece comprising an elongated body portion 24, an abutment portion 26 and a transition portion 28 between the body portion 24 and the abutment portion 26.

The body portion 24 has a generally circular cross section and includes a helical thread 27 extending substantially the length of the body portion 24. While the body portion 24 may be tapered, it has been found that a cylindrical, non-tapered construction is best. As such, the body 24 has equal contact with surrounding material at both a point (x) adjacent the distal end 30 and a point (y) adjacent the transition portion 28. As shown in the Figures, the thread 27 includes a thread angle α of approximately 22 degrees to a perpendicular of a longitudinal axis 29 of the body portion 24. FIG. 4 shows further details of the thread 27. An upper thread surface 32 extends away from the body portion 24 generally perpendicular to the longitudinal axis 29 while a lower thread surface 34 slopes at an angle from an outer thread edge 36 to the body portion. It should be noted that this design presents a reverse-angle of thread. A distal end 30 of the body portion 24 is rounded and includes no sharp corners or other sharp edges. In this manner, it is unlike a typical screw. The pitch angle of 22 degrees is substantially greater than found in any currently available dental implants known to the inventors and has been found to be generally preferred.

An outer surface area 38 of the transition portion 28 and the body portion 24, including the thread 27 is bead blasted, similar to sand blasting, during its manufacturing process to result in a textured outer surface area 38. The bead blasting process results in a rough surface area 38 that includes a plurality of very small protrusions and/or depressions about the outer surface area 38. Other types of mechanical or physical texturing of the outer surface area 38 may be utilized while remaining within the scope of the invention. Typical prior art implant surface areas are sprayed with a titanium plasma spray to achieve a textured surface. The texturing achieved through the bead blasting of the present invention increases the speed with which the living jaw bone osseointegrates with the implant 22 after surgical placement. Also, the bead blasting technique decreases the cost and complexity of the manufacturing process.

The implant 22 is specifically designed to present a narrow profile. That is, due in part to its one piece construction, the implant 22 depicted in FIGS. 2-4 includes a body portion 24 having a diameter ‘d’ including the thread 27 of approximately 2.4 mm. Conventional dental implants range in diameter from approximately 4.0 mm (including any threading) and greater. It is noted that in accord with the present invention, diameters smaller than the 2.4 mm diameter ‘d’ of the embodiment of the invention depicted in the Figures can be obtained in practicing the invention. One advantage of a narrow profile for the implant 22 is that the narrow profile can be utilized for implant placement especially in the mandibular jaw. Typically, in anterior incisal areas where the edentuous boney areas are narrow, limited mass of bone exists. This implant's narrow profile makes it feasible and possible for implant anchoring in these areas. Being one piece, this invention makes it stronger than a two-piece implant system with the same diameter.

The abutment portion 26 is generally conical having a generally circular cross section. An abutment base 39 is adjacent the transition portion 28. A proximal end 40 of the abutment portion 26 has a cross section with a smaller diameter than a cross section of the abutment base 39. The abutment portion 26 includes a longitudinal groove 42 for mating with any of a number of known tools for assisting surgeons in inserting, screwing, holding or otherwise manipulating dental implants. The abutment portion 26 includes a polished surface area 26a.

The implant 22 is made from medical grade titanium or titanium alloy. The implant 22 may be made from any suitable medical grade material of sufficient strength characteristics and properties.

As noted, the implant 22 shown in the Figures is constructed from a single piece of material, in this case a titanium alloy. While the body portion 24, abutment portion 26 and transition portion 28 can be a single piece, they can be separately constructed and then fused together or otherwise jointed to form a single, unitary, integrated piece prior to implantation.

The bead blasted surface of the implant 22 of the present invention increases the speed and effectiveness of the osseointegration process as compared to prior art implant systems. The applicants have observed that the textured outer surface area 38, the pitch angle of 22 degrees and the cross-section shape of the thread 27 each, and in combination, increase the anchoring effects of the osseointegration process.

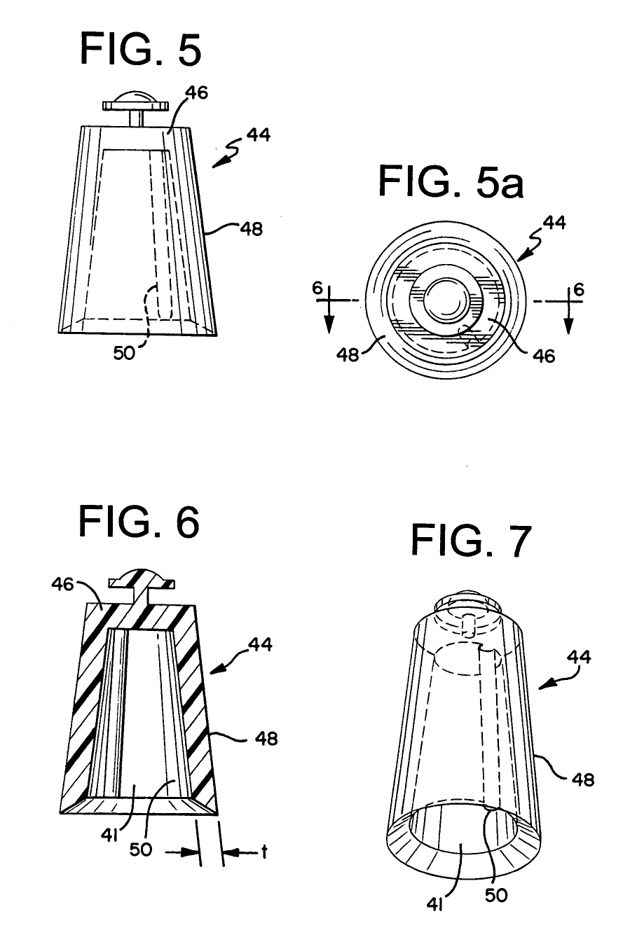

FIGS. 5-7 depict an impression transfer thimble 44, for use in the present invention. The thimble 44 is shaped generally to closely correspond and fit over the shape of the abutment portion 26 of the implant 22. The thimble 44 includes a base wall 46 and an annular side wall 48 depending therefrom as seen in FIGS. 5-7. The base wall 46 and side wall 48 are relatively thin. In the embodiment depicted in FIGS. 5-7, the base wall 46 and side wall 48 have a thickness ‘t’ of approximately 0.5 mm. An interior surface 41 of the side wall 48 includes a longitudinal protrusion 50 shaped to align with and correspond to the longitudinal groove 42 of the abutment portion 26. The impression transfer thimble 44 is typically constructed from an acrylic type polystyrene or other acrylic compatible with the adhesives typically used with the transfer thimble 44.

FIGS. 9 and 10 show a pattern burn out thimble.

A pattern thimble 52 would also include a base wall 54 (with extending prongs 57) and an annular side wall 56 and is over-all shaped to closely correspond to and fit over the shape of the abutment portion 26 of the implant 22. However, an interior surface 58 of the side wall 56 is smooth and includes no protrusions or grooves. In the Figures, the base wall 54 is shown to have the extending prongs 57 catch the thimble when it is pulled with impression material. However, it should be understood that the base wall 54 can be constructed without prongs as in FIG. 9A. The thimble 52 is made of a lab burn-out resin. The pattern thimble 52 is used in the conventional manner.

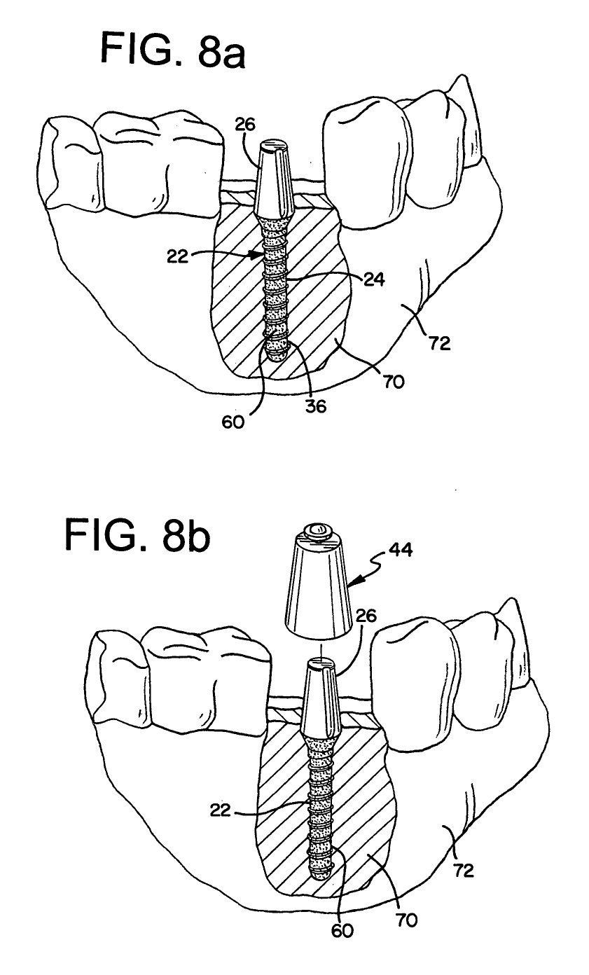

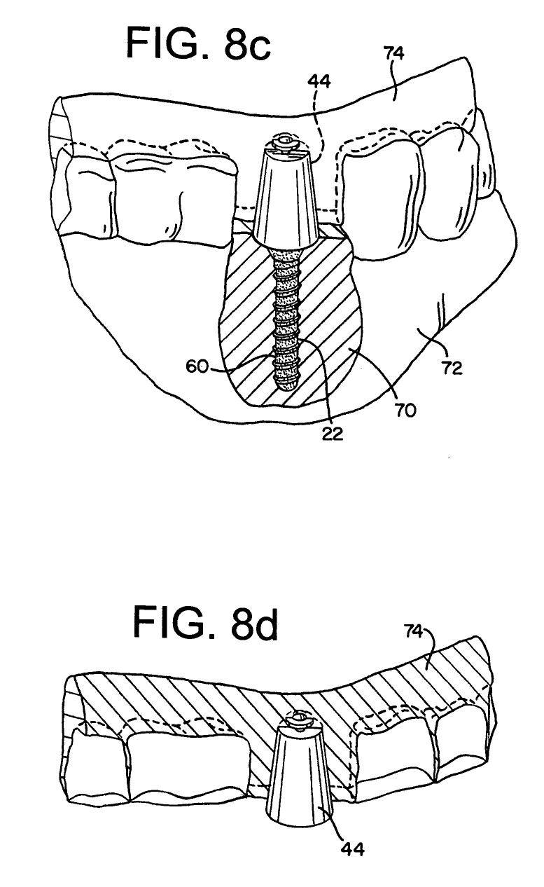

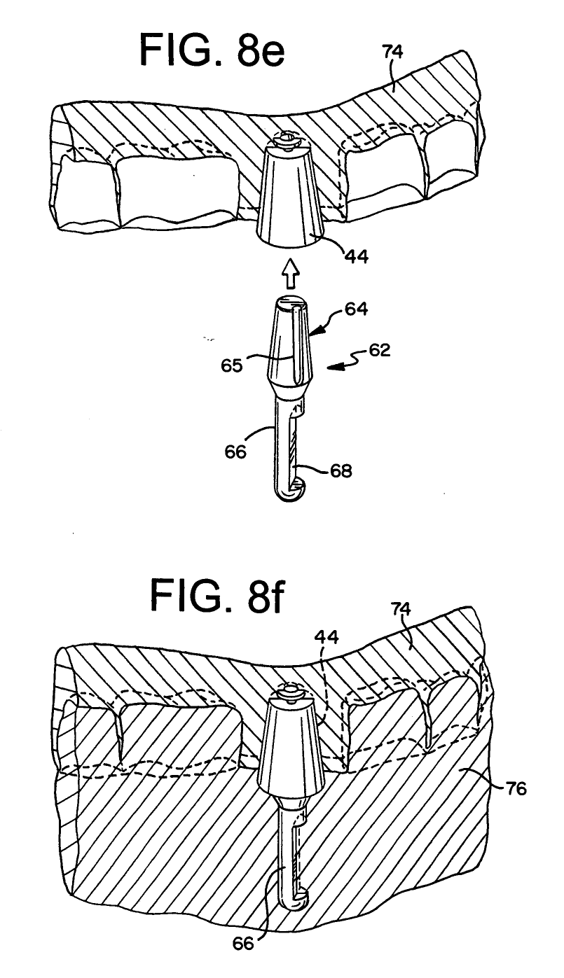

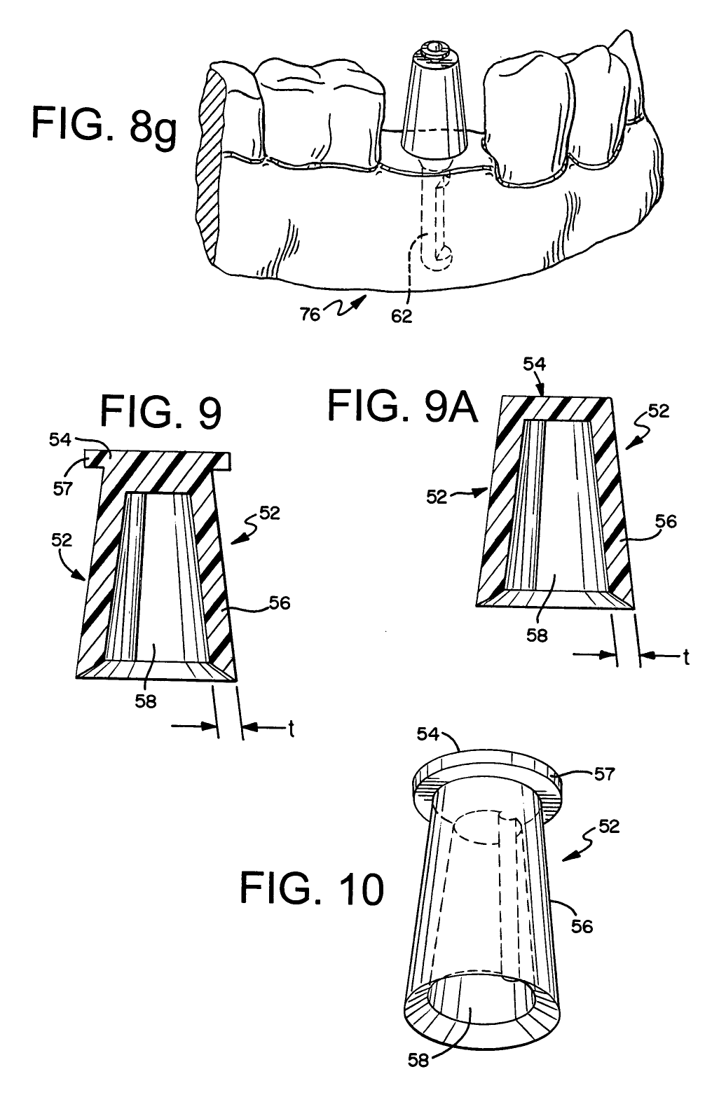

In use (FIGS. 8a-8g) an oral surgeon will prepare the surgical site where the implant 22 is to be placed in a patient's jaw. This includes accessing the jaw bone 70 which may include incising the surrounding gingival tissue 72. Any remaining portion of a prior existing natural tooth structure is removed. The specific site of implantation is then drilled or reamed by the surgeon so as to accommodate the implant. A cylindrical recess 60 (FIGS. 8a-8g) of a diameter slightly smaller than the diameter ‘d’ of the body portion 24 of the implant 22 is created. In this case, the diameter of the recess 60 should be slightly less then 2.4 mm. The surgeon then cleans the recess 60.

The body portion 24 of the implant 22 is then screwed into the recess 60 using any known implant driver or other tool adapted to fit the implant 22. The outer thread edge 36 then engages the jaw bone within the recess 60, cutting a corresponding groove (not specifically shown) in the jaw bone. In this way, the implant becomes securely held or anchored by the jaw bone. The surgeon or dentist may then fit a temporary cap or crown to the abutment portion 26 (without any degradation) immediately after surgery using a cement or other adhesive during this healing period. The healing and osseointegration time allows the gingival tissue time to heal and any swelling to subside.

It is noted that at this point (FIG. 8a), substantially all of the body portion 24 is located within the recess 60, and substantially all of the abutment portion 26 is located above the gingival tissue level.

The impression thimble 44 is placed upon the abutment portion 26 to cover same (FIG. 8c). Impression material is formed over the thimble 44 and the surrounding area of the jaw, including the surrounding teeth and gum or gingival lines (FIG. 8d). When the impression 74 material hardens, it is removed from the jaw with the thimble 44 embedded therein. The impression 74 is then typically sent to a laboratory to be used in creating the final prosthesis.

A lab technician will then insert an analogue 62 into the thimble embedded in the impression (FIG. 8e). The analogue 62 simulates the actual implant and its position in the patient's mouth, to be seen. The analogue 62 includes an abutment portion 64 that exactly duplicates the abutment portion 26 of the implant 22 in the patient's jaw bone, including a longitudinal groove 65. The analogue 62 also includes a body portion 66 very generally corresponding to the previously described body portion 24 of the implant 22. However, the body portion 66 does not include any threads. Rather, it includes a flattened surface 68.

The technician will then pour up the impression in artificial stone 76 having the embedded thimble 44 and analogue 62 in place (FIG. 8f). Once the poured material hardens, it forms a plaster or stone cast 78 and is removed from the impression (FIG. 8g). The analogue 62 is now embedded within the stone cast which now forms a precise positive model of the patient's jaw duplicating the location and orientation of the abutment portion 24 in relation to the surrounding teeth and gum lines.

The technician uses this model to form and create the final tooth prosthesis using a well known wax bum out technique not described in detail here. In short, the technician will then place the pattern thimble 52 over the abutment analog portion 64 protruding from the stone cast. The technician then uses a wax material to form a wax model of a final prosthesis over the pattern thimble 52. The absence of any longitudinal protrusion in the pattern thimble makes it easier for the technician to form the wax model. This is because the pattern thimble 52 can rotate about the abutment portion 64 making minor modification to the wax model easier to make by the technician. Because there is no timing device procedure, the restorative crown can spin or rotate 360° freely on the abutment form.

The lab bum-out thimble 52 with round wax (vent) sprue attached is connected to a sprue former and casting ring. This casting ring assembly is filled with a christolbolite investment plaster. The ring is heated and the wax is “burnt out.” That is, the wax melts and flows leaving a void in the heating casting ring. Gold or some type of metal is melted and forced in the “void” duplicating the bum out pattern thimble. The casting is removed from the casting ring assembly dressed to receive the porcelain veneers covering the metal to produce a cosmetic implant crown prosthesis. This prosthesis is then returned to the dentist. (Of course, in many instances, a dentist may handle his or her own prosthesis casting.)

The dentist will then remove the temporary cap or crown and replace it with the final prosthesis. The final prosthesis will typically be secured to the abutment portion 26 using a cement or other relatively permanent adhesive.

While the specific embodiments and various details thereof have been illustrated and described, numerous modification come to mind without significantly departing from the spirit of the invention and the scope of protection is only limited by the following claims.

What is claimed is:

1. A dental implant for surgical placement in a living jaw bone at least partially covered with gingival tissue and for mounting a cosmetic tooth prosthesis, the implant comprising:
an elongated body portion adapted to be received by the living jaw bone; and,
an abutment portion adapted to extend from the jaw bone and at least partially past the gingival tissue and adapted to receive the cosmetic tooth prosthesis wherein the body portion and the abutment portion form a single unit.

2. The dental implant of claim 1 wherein the elongated portion and abutment portion are formed from a single piece of material.

3. The dental implant of claim 1 wherein the body portion has a generally circular cross section.

4. The dental implant of claim 3 wherein the body portion includes threads.

5. The dental implant of claim 4 wherein the body portion is cylindrical.

6. The dental implant of claim 5 wherein the body portion including the thread has a diameter of less than 2.5 millimeters.

7. The dental implant of claim 1 wherein the body portion is equal to or less than 3.0 millimeters wide.

8. The dental implant of claim 1 wherein the body portion is equal to or less than 2.5 millimeters wide.

9. The dental implant of claim 1 wherein the body portion has an outer surface that is textured and adapted to increase an osseointegration process between the body portion and the living jaw bone.

10. The dental implant of claim 9 wherein the surface includes a plurality of protrusions.

11. The dental implant of claim 1 wherein the body portion includes a thread and the thread includes a pitch angle in the range of greater than or equal to 11 degrees and less than or equal to 45 degrees.

12. The dental implant of claim 13 wherein the pitch angle is approximately 22 degrees.

13. The dental implant of claim 1 wherein the body portion includes an embedded end distal from the abutment, the embedded end having a rounded end surface.

14. The dental implant of claim 1 including a transition portion located between the body portion and the abutment portion and adapted to be adjacent to the gingival tissue.

15. The dental implant of claim 14 wherein the gingival portion is either textured or not textured.

16. A dental implant system for replacing one or more of a patient's teeth comprising:
a dental implant having a body portion adapted for implantation into a living jaw bone of the patient and an abutment portion adapted to extend beyond a gingival tissue covering the living jaw bone, wherein the abutment portion includes an annular abutment seat;
an impression transfer thimble having a thimble having an annular thimble seat adapted to mate with the annular abutment seat; and,
a resin casting pattern cap having an annular cap seat adapted for mating with the annular abutment seat such that the resin cap has a 360 degree universal abutment position with respect to the abutment portion.
